(19) United States
(12) Patent Application Publication
(10) Pub. No.: US 2012/0170014 A1
(43) Pub. Date: Jul. 5, 2012

(54) Photolithography system using a solid state light source

(75) Inventors: Teri W. Odom, Chicago, IL (US); Mark D. Huntington, Evanston, IL (US)

(73) Assignee: Northwestern University

(21) Appl. No.: 13/374,262

(22) Filed: Dec. 19, 2011

Related U.S. Application Data
(60) Provisional application No. 61/460,529, filed on Jan. 4, 2011.

(51) Int. Cl. G03B 27/54; G03B 27/32

(52) U.S. Cl. 355/70; 355/77

(57) ABSTRACT

A photolithography system based on a solid-state light source having LEDs is provided. Solid-state photolithography using the solid state light source can achieve high quality patterns over a wide range of length scales at a fraction of the cost of contact mask aligners. 2D nanoscale and 1D microscale patterns can easily be created over a 60 cm² substrate surface area.

This application claims benefits and priority of provisional application Ser. No. 61/460,529 filed Jan. 4, 2011, the entire disclosure of which is incorporated herein by reference.

### CONTRACTUAL ORIGIN OF THE INVENTION

This invention was made with government support under CMMI-0826219 awarded by the National Science Foundation. The government has certain rights in the invention.

### FIELD OF THE INVENTION

The present invention relates to photolithography systems and, more particularly, to a photolithography system that uses a solid state light source to illuminate a masked substrate.

### BACKGROUND OF THE INVENTION

Advances in photolithography have enabled the development of micro electrical and mechanical systems (MEMS)^{[1]}. The primary challenge to producing such structures is the high cost of the infrastructure and processing tools necessary for fabrication, such as dedicated cleanroom facilities and mask aligners. Although soft lithography methods have enabled low-cost solutions for the rapid prototyping of micro- and nanometer-patterns, mask aligners are still often required to fabricate the masters.^{[3, 4]}

### SUMMARY OF THE INVENTION

The present invention provides in one illustrative embodiment a lens-less photolithography system having a light source comprising a plurality of solid state light-emitting devices, such as for example an array of light-emitting diodes (LEDs), for illuminating a masked substrate. The present invention provides in another illustrative embodiment a photolithography system having a light source comprising a plurality of solid state light-emitting devices, such as for example an array of light-emitting diodes (LEDs), for illuminating a masked substrate with or without a lens, wherein certain light-emitting devices are more or less energized to improve uniformity of illumination. The LEDs can be selected from semiconductor light-emitting diodes, organic light-emitting diodes, and polymer light-emitting diodes. The LEDs are selected to emit a wavelength of light (e.g. UV light) that is compatible with g-line, i-line, or other particular photoresist being employed as the photomask. The solid state light source can be powered by a battery power source, or alternately by AC power through an AC to DC converter.

In a particular illustrative embodiment of the invention, a plurality of UV LEDs are arranged in a densely packed array and a light diffuser is disposed between the array and the masked substrate, which can be a silicon wafer for purposes of illustration and not limitation. Certain LEDs in an array can be more or less energized (e.g. with more or less electrical current) than others to improve uniformity of illumination of the masked substrate. Pursuant to an illustrative method embodiment of the invention, UV light emitted by the light source passes though the light diffuser and impinges on the masked substrate, such as a masked Si wafer, in a single exposure step without the need for a lens between the light source and the substrate.

Solid-state photolithography (SSP) methods pursuant to embodiments of the invention can produce patterns as small as 200 nm over 4-inch Si wafers. If desired, the invention can be practiced without a cleanroom. The invention can provide greater accessibility of pattern structures with dimensions ranging from 200 nm to over 100 μm to expedite the integration of sub-wavelength patterns, microfluidic devices and MEMS into a wide range of research areas. The invention can be practiced using positive or negative tone photoresists.

Other advantages of the present invention will become more apparent from the following detailed description taken with the following drawings.

### BRIEF DESCRIPTION OF THE DRAWINGS

FIG. 1 depicts a solid state photolithography system (SSP system) pursuant to an illustrative embodiment of the invention.

FIG. 2 is a scanning electron microscopy (SEM) image of high quality sub-micrometer photoresist patterns made using SSP. The inset image is taken at higher magnification. The SEM image confirms and highlights the fidelity of the SSP system using a hard contact photolithography mask (0.75 μm Cr lines on a 2 μm pitch) and without needing a vacuum system.

FIG. 3A shows an optical microscopy image of diffraction from a hexagonal array of photoresist posts (d=180 nm, aₒ=400 nm) across a 3 inch Si wafer made using a PDMS phase-shifting mask.

FIGS. 3B, 3C and 3D are SEM images of a 4 inch Si wafer containing a hexagonal array of phototresist posts at different areas of the wafer wherein FIG. 3B is taken in the wafer center (0 cm), FIG. 3C is taken on the left (−4 cm from the wafer center), and FIG. 3D is taken on the right (+4 cm from the wafer center).

FIG. 4 is an optical microscopy image of the inlet of a PDMS Y-channel molded from a SU-8 master made using an SSP system with a different light source and illustrates flowing dye in one inlet (upper stream) and a different dye in the other inlet (lower stream). The arrows indicate the direction of flow.

FIG. 5 is an elevation view of the purchased flashlight circuit board with an array of UV LED's substituted for the white-light LED's.

### DETAILED DESCRIPTION OF THE INVENTION

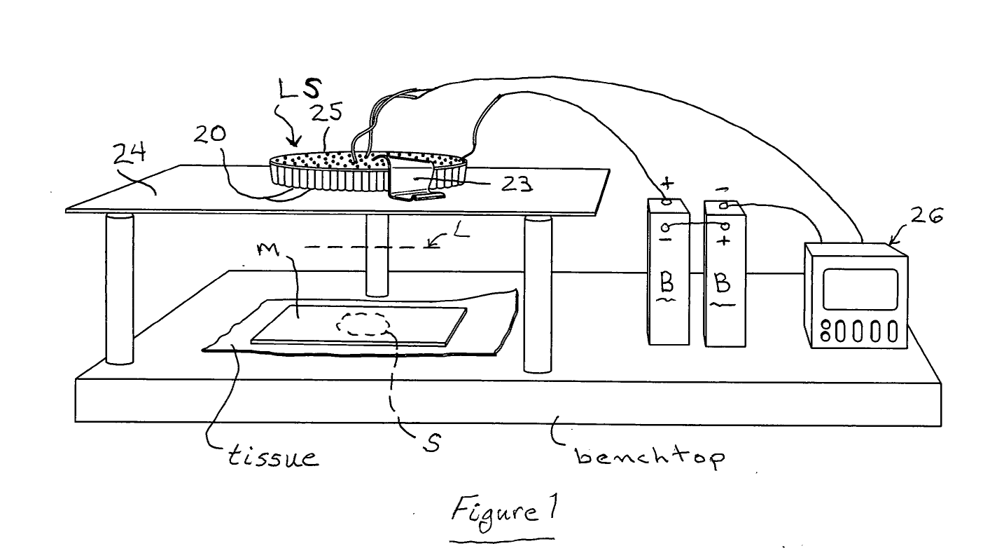

The present invention involves in one illustrative embodiment a solid state photolithography system (SSP system) and method that can produce patterns as small as 200 nm. To this end, the present invention provides in one illustrative embodiment a lens-less photolithography system and method embodying a solid state light source LS, FIG. 1, for illuminating a masked substrate wherein the solid state light source comprises a plurality of light-emitting diodes (LEDs) arranged in an array. The LEDS are arranged in a densely packed array that, in effect, acts as single light source. The LEDs can be selected from semiconductor light-emitting diodes, organic light-emitting diodes, and polymer light-emitting diodes. The LEDs are selected to emit a wavelength of light (e.g. UV light of particular wavelength) that is compatible with g-line, i-line, or other particular photoresist being employed for the photomask on the substrate. The solid state light source can be powered by a DC battery power source, or alternately, by building AC power through an AC to DC converter. The SSP system is compact and portable and can be used on a benchtop, desktop, or other work surface in a laboratory or other setting.

Referring to FIGS. 1 and 5, in a particular illustrative embodiment of the invention, a solid state light source LS has a plurality of UV LEDs 20 that are arranged in a circular or other array 22. Importantly, the LED array can be selected to have any shape and size to provide scalability for a desired pattern area. The light source is supported on a light diffuser 24 having the form of a ground glass plate, which is disposed between the array 22 and a masked substrate S (e.g. Si wafer) to substantially uniformly illuminate the substrate. The light diffuser plate is supported on vertical support posts as shown. Further details of an illustrative solid state light source LS are provided in the Examples below.

A digital timer 26 powered by a 12V power source can be connected between the LEDs and the batteries and can be used to control exposure time, or a manual switch can be used to this end. As will be described in the Examples below, certain LEDs in the array can be more (or less) energized than others to further improve uniformity of illumination of the substrate S.

In another illustrative embodiment of the invention, a photolithography system is provided having a light source LS comprising a plurality of the above-described solid state light-emitting devices for illuminating a masked substrate, wherein certain light-emitting devices are more or less energized to improve uniformity of illumination. This embodiment can employed without a lens or with an optional lens L, illustrated by a dashed line in FIG. 1.

An illustrative photolithographic method embodiment of the present invention involves emitting light from the LED array 22, diffusing the light from the array using the light diffuser 24, and impinging the diffused light on the masked substrate S in a single exposure step. The solid-state photolithography (SSP) method pursuant to the invention can produce patterns as small as 200 nm over 4-inch diameter Si wafers (4-inch wafer is a conventional wafer) without needing the environmental control of a class 1000 (or lower) cleanroom and provide greater accessibility of pattern structures with dimensions ranging from 200 nm to over 100 μm to expedite the integration of sub-wavelength patterns, microfluidic devices and MEMS into a wide range of research areas.

The following Examples are offered to further illustrate, but not limit, the present invention:

### EXAMPLES

In this Example, GaN-based LEDs that emitted 405-nm UV light (10 nm FWHM) were used because of compatibility with g-line photoresists, which have a broad absorption spectrum from 350 to 450 nm.^{[9]} A circular array of these UV LED's was used as the solid state source LS because of (1) potential for scalability and (2) uniformity in exposure conditions.

The circular array was built using a purchased (commercially available) circular circuit board template 25 (see FIGS. 1 and 5) taken from a 4.75-in diameter LED flashlight (Guide Gear® 200 LED flashlight), wherein each of the original 200 white-light LEDs was replaced with a UV GaN-based LED purchased from RadioShack for an average price $0.65 each. The GaN-based LEDs were connected in parallel on the circular circuit board template 25 as were the original white-light LEDs.

The entire circular circuit board template 25 was connected to and powered by eight AA batteries (6 V, 5000 mA-h) contained in two battery packs B (see FIG. 1). Because the solid state UV LED light source required 4 Amperes, the batteries could sustain 1.25 h of continuous exposure time. The circuitry was designed such that if one LED failed, the other LEDs would be unaffected. The LED array was held in place on top of a ground glass light diffuser 24 by a piece of tape 23. A tissue was placed on the workbench to protect the mask M as shown in FIG. 1.

The circular array of UV LED's constitutes an equivalent single, substantially homogenous solid state light source LS as a result of placement of a ground glass diffuser 24 (purchased from Edmunds Optics) between the LED array and the masked substrate to be exposed (i.e. placement of the light diffuser placed in front of the substrate). The LEDs arranged in this circular circuit configuration produced a 15% spatial gradient in optical intensity from one edge to the opposite edge of the source because of resistive losses in the wires. To remove this gradient, two additional positive electrodes (battery electrodes) were connected between the LED in the center of the array and those on the opposite ends of the array to provide more (or less) electrical current thereto. In general, energization of the individual LEDs can be adjusted in this way to reduce spatial gradient. The presence of the ground glass light diffuser increased the uniformity of the LED light source by ±6% such that the spatial intensity did not vary more than ±4% across the 64-cm² area light source. Uniformity was defined as the percentage change of dose between the highest and lowest intensity points across the middle section of the light source; ±4% is comparable to state-of-the-art Suss MicroTech MA/BA 6 (±5%).^{[11]} The total cost of the 200-LED, SSP system was <$400.

This array-based design of the solid-state light source is advantageous to alleviate the need for sophisticated exposure optics used in contact mask aligners and, significantly, allows the exposure area to be easily scaled. There are several other advantages in using an LED array over an Hg-vapor lamp, including the short rise time to maximum optical intensity (<300 ms) and low electrical power consumption (<6 W). For example, in traditional contact mask aligners, the Hg-lamp source requires several minutes to reach full optical power, and a mechanical shutter is used to supply a specified dose of UV light. In contrast, the solid state LED array pursuant to the invention reached full power (5.5 W/cm²) in less than half of a second after the voltage was applied, and digital timer 26 (see FIG. 1) was used to control the exposure dose with an accuracy of 10 ms.^{[12]} In applications where the exposure times were not critical to <0.5 s, a manual electrical switch can be sufficient to control exposure time instead of the digital timer was sufficient. Another advantage of the SSP system is that the total power consumption of the 200-LED array is less than 0.2% of the power required for Hg-vapor lamps for the same exposure time.^{[6]} This low-power requirement allows the system to run on AA batteries instead of a high-voltage power supply, a feature that contributes to portability. Additionally, GaN-based LEDs have been shown to last more than 50 times longer than Hg-vapor lamps.^{[7, 8]}

The above-described SSP system was tested using traditional photomasks (fused quartz/Cr windows) as well as unconventional masks [(poly(dimethylsiloxane) (PDMS) masks and transparency films)] to determine capabilities and to compare against alterative photolithography methods. Typically, photolithography is performed by exposing photoresist in contact with a hard photomask; minimum feature sizes are around 1 μm.^{[1]} Although a vacuum is usually required for uniform contact between the photomask and the resist, the SSP pursuant to the invention was not designed with this feature so that complexity and cost would be reduced. Thus, the mask M (see FIG. 1) was simply pressed into contact with the substrate, which resulted in high quality patterns over ˜70% of the exposed area, which is ca. 4 cm² for this example.

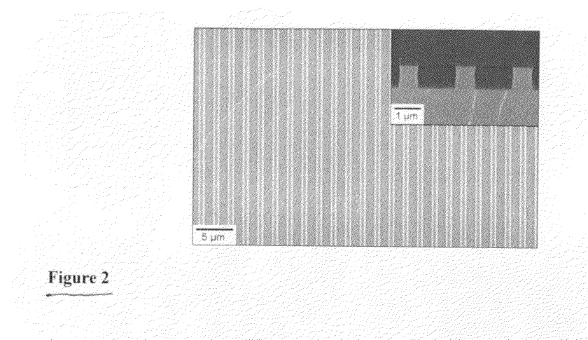

The capabilities of SSP were evaluated with hard photomasks patterned with one-dimensional lines (750-nm wide Cr lines on a 2 μm pitch). Si wafers with a thin (500 nm) layer of Shipley 1805 photoresist (a positive tone photoresist) were exposed through this mask to form 500-nm tall lines in the photoresist, see FIG. 2. Because the sidewalls of the lines were fairly vertical, these patterns can be easily transferred into functional materials. The ridges in the sidewalls are characteristic of thin film interference between the mask and the substrate, and the standing wave patterns can be removed using antireflective coatings.^{[3]}

In addition, experiments were carried out using contact photolithography masks with microscale features (3-μm solid circles on a 4.5-μm pitch). Uniform patterns were observed across a 3-inch diameter wafer, which demonstrates how SSP can readily be used with traditional masks.

As mentioned, the photomasks (fused quartz/Cr windows) with arrays of 750-nm lines spaced by 2 μm were used for contact photolithography. The SSP method using the 405-nm sold state light source was carried out by spin-coating hexamethyldisilazane (HMDS, Sigma Aldrich®) primer on Si wafers at 4000 rpm for 40 seconds; spin-coating Shipley 1805 positive tone photoresist on Si wafers at 5000 rpm for 60 seconds baking the photoresist at 105° C. for 2 min; exposing the photoresist through the contact photomask for 3.5 seconds while pressing the mask into contact by hand; and developing the resist in Microposit 351 Developer (Rohm and Haas Electronic Materials LLC, diluted 1:5 in water) for 60 seconds.

Recent advances in nanofabrication have resulted in the generation of sub-wavelength features over large areas.^{[3, 6, 14-22]} In particular, phase-shifting photolithography (PSP) is a soft lithographic technique that uses PDMS phase masks to form photoresist patterns with lateral dimensions as small as 50 nm.^{[16]} IPSP takes advantage of differences in refractive index at the air-PDMS interface, which produces nodes in the near-field optical intensity because of destructive interference. Exposure of resist through PDMS masks patterned with microscale features (0.5-50 μm) produces, on average, 200-nm linewidths at the edges of the features in the mask.^{[14, 15]} When the recessed features of the mask are decreased to less than 300 nm, however, the masks produce patterns that are the same size laterally as the recessed structures of the PDMS mask.^{[21]} PDMS phase masks are typically prepared by molding PDMS against masters made from photoresist,^{[15]} polyurethane (PU)^{[16]} or Si.^{[6]}

In another example illustrating an embodiment of the invention, a composite PDMS phase masks (h-PDMS/184 PDMS)^{[11]} was created from a PU master patterned with a hexagonal array (d=180 nm, a₀=400 nm) of posts (h=280 nm) following a similar procedure to that in reference [22]. Although the total patterned area of the master was about 80 cm², there were some defects, including variations in height from the center of the patterned area to the outer edge (±4 cm)); therefore, such defects were also transferred into the PDMS phase mask.

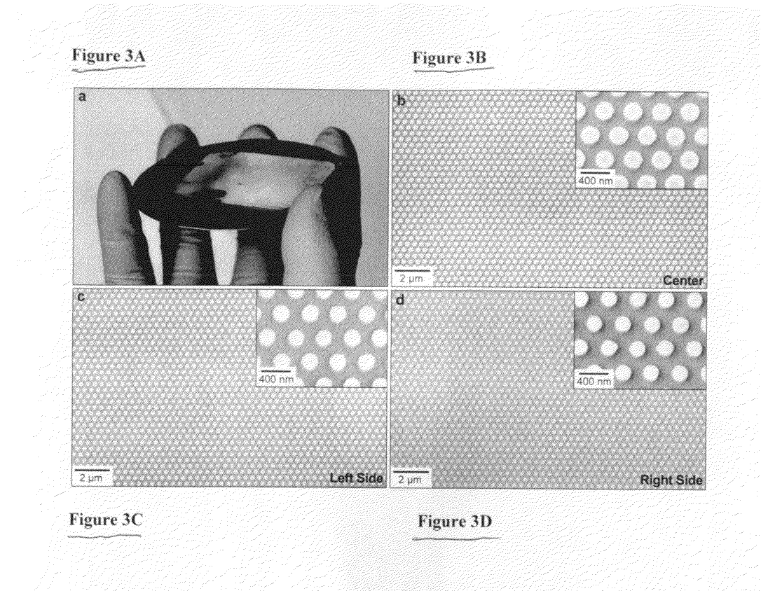

The above-described SSP system pursuant to the invention was used to expose Si wafers with a thin (200 nm) layer of Shipley 1805 positive tone photoresist through these PDMS masks to form 200-nm tall photoresist posts (FIG. 3A, 3B, 3C, 3D). The exposure times and overall quality of the patterns were found to be similar to those made using the same PDMS mask and state-of-the-art mask aligners.^{[22]} For example, FIG. 3A shows that a single exposure from the SSP system can form sub-wavelength patterns that exhibit uniform diffraction across 3-in wafers. In addition, hexagonal arrays were patterned on larger Si substrates (4-in wafers). The photoresist patterns were uniform across several cm (FIGS. 3B, 3C, and 3D) but not across the entire wafer because of the slight differences in feature sizes across the PU master. These differences in width were not correlated with intensity variations near the edges of the LED light source.

The composite PDMS masks patterned with a hexagonal array (d=180 nm, a₀=400 nm) of recessed posts (h=280 nm) were prepared for phase shifting photolithography (PSP) according to reference [15]. The SSP method using the 405-nm solid state light source was carried out by spin-coating HMDS on Si wafers at 4000 rpm for 40 seconds; spin-coating Shipley 1805 diluted 1:2 with PGMEA on Si wafers at 5000 rpm for 60 s; baking the photoresist at 105° C. for 2 min; exposing the photoresist through the PSP mask for 3.5 seconds; and developing the photoresist in 351 developer (1:5 in water) for about 5 seconds.

In further examples, the SSP system pursuant to the invention was demonstrated to be compatible with different photoresists. In particular, the SSP system was used to create patterns in SU-8 negative tone photoresist (MicroChem®). A different type of rudimentary photomask was used, often referred to as a “transparency mask,” which can be produced by using laser printers to print patterns (minimum feature sizes ca. 10 μm^{[28]}) on transparent polymer films.^{[24-28]} The most common use of these masks has been to generate masters in SU-8 photoresist for PDMS microfluidic channels.^{[23]} Since SU-8 is an i-line photoresist, the 405-nm light source used previously could not be used as an exposure source. Thus, in the solid sate light source for these further examples, a commercially available 365-nm flashlight (Nichia®) solid state light source was substituted for the GaN-based LED light source of the lens-less system of FIG. 1 (i.e. no optional lens L). The 365-nm flashlight (Nichia®) solid state light source comprised a circular array of five LEDs. Like the SSP system set-up in FIG. 1, a ground glass diffuser was used to increase the local homogeneity of illumination of the light source.

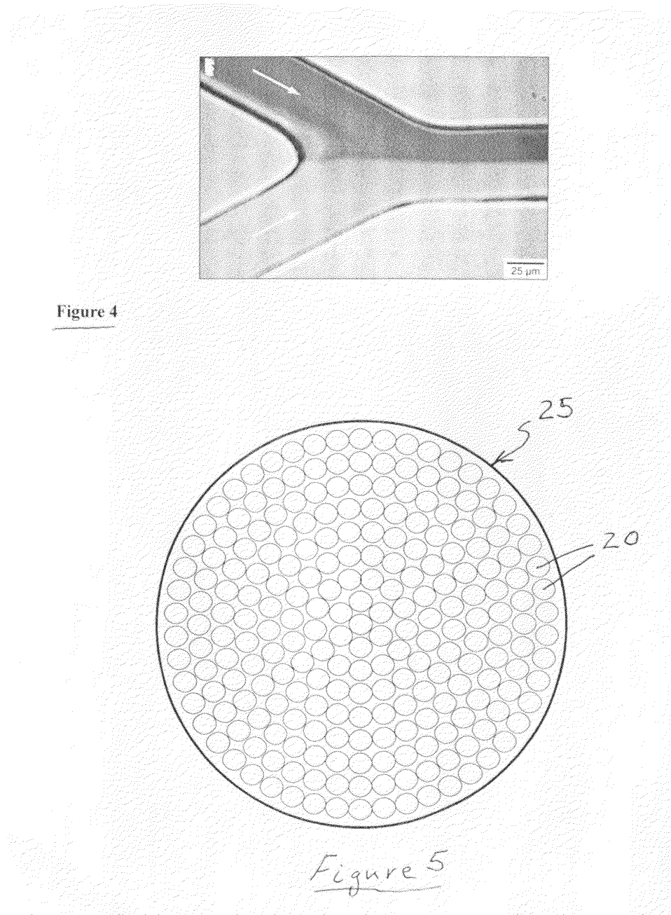

The modified SSP system pursuant to the invention was used to expose SU-8 through a transparency mask for the creation of a master with a Y-pattern for a microfluidic device. When the UV light source was the same distance above the resist as in FIG. 1 (5.5 cm), however, exposure times exceeded 180 min for SU-8. Therefore, the distance between the UV light source and the substrate was decreased to 1.5 cm. Si wafers with a layer (25 μm) of SU-8-2500 photoresist were exposed through the transparency mask for 40 min to form a Y-channel with channel widths of 50 μm and a height of 25 μm (FIG. 4). Because of the lower intensity of the 365-nm light source, the exposure times were much longer than those when a mask aligner was used.^{[29]} PDMS was then molded against the SU-8 master to form a Y-channel system, and then three holes (two inlets and a single outlet) were punched into the channels.^{[23]} The PDMS mold was exposed to an oxygen plasma for 60 s before being sealed against a glass slide. A red dye was introduced in one inlet (upper inlet) and a blue dye in the other (lower inlet); laminar flow was observed at the interface of the two fluid streams (FIG. 4). The two streams remained separated throughout the entire 4.5-mm channel until mixing at the outlet. With the UV flashlight (Nichia®) solid state light source as the light source LS for i-line resists, the total cost of the SSP system was <$50.

The transparency masks (Pageworks®) with a Y-channel and channel widths of 50 μm were prepared according to a procedure described in references 25, 26. The SSP method using the 365-nm solid state light source was carried out by spin-coating SU-8 2025 (Micro Chem®) photoresist on Si wafers at 3000 rpm for 30 seconds; pre-baking the SU-8 at 95° C. for 2 min; exposing the SU-8 through the transparency mask for 40 min; post-baking the sample at 95° C. for 1 min; and developing the SU-8 PGMEA (Sigma Aldrich®) for 60 seconds. PDMS was then molded against this master and removed from the substrate to form the top of the channel system. The PDMS was then placed into conformal contact with a glass slide (VWR® microscope slides 25×75 mm, 1 mm thick) that was pretreated in an oxygen plasma for 30 s (Harrick® PDC-324).

The examples illustrate that embodiments of the present invention can provide a photolithography system based on a solid-state light source that can be used with a wide range of photomasks. This simple SSP system was able to create photoresist patterns with critical feature sizes around 200 nm across 4-inch wafers, and the array design of the UV LED light source allows the exposure area to be readily scaled. The SSP system and method are ideal for fabricating patterns that require only a single exposure step. High quality patterns could be generated by practice of the invention. Practice of the invention does not require specialized cleanroom equipment such as mask aligners, a vacuum system, and high voltage power supplies. The ability of the SSP system and method to prototype a wide range of structures will accelerate the development of micro- and nanoscale devices and other applications.

Although the present invention has been described with respect to certain embodiments thereof, those skilled in the art will appreciate that modifications and changes can be made therein without departing from the spirit and scope of the invention as defined in the appended claims.

References, which are incorporated herein by reference:
1. M. Madou, in Fundamentals of Microfabrication CRC Press, New York, 1997, Ch. 1
2. H. Daiguji, Chem. Soc. Rev. 2010, 39, 901
3. Y. Xia, J. A. Rogers, K. E. Paul and G. M. Whitesides, Chem. Rev. 1999, 99, 1823.
4. D. B. Wolfe, D. Qin and G. M. Whitesides, Methods in molecular biology, 2010 583, 81.
5. E. M. Lucchetta, J. H. Lee, L. A. Fu, N. H. Patel and R. F. Ismagilov, Nature, 2005 434, 1134.
6. J. Henzie, M. H. Lee and T. W. Odom, Nat. Nanotechnol., 2007 2, 549.
7. Philips Lumileds, Evaluating the Lifetime Behavior of LED Systems. Philips inc. White Paper, 2004, 1-16.
8. J. Y. Zhan and I. W. Boyd, Appl. Surf. Sci., 2000 168, 296.
9. Microposit s1800 series photo resist, Material Data Sheet, http://www.nano phys.kth.se/nanophys/facilities/nfl/resists/S1813/s1800seriesDataSheet.pdf (accessed February 2011).
10. Spectronics SB-100P Series UV Lamp, specifications sheet, http://www.deterco.com/products/Spectronics/spectronics_SB-100P.htm
11. Süss MicroTec MA/BA6 Mask Aligner, specifications sheet, http://www.suss.com/products/mask-aligner/ma-ba6-gen2.html
12. Panasonic LTH4 Timer, specifications sheet, www.ctiautomation.net.
13. T. A. Brunner, Proc. SPIE 1991 1466, 297
14. J. A. Rogers, K. E. Paul, R. J. Jackman and G. M. Whitesides, Appl. Phys. Lett. 1997, 70, 2658.
15. T. W. Odom, J. C. Love, D. B. Wolfe, K. E. Paul and G. M. Whitesides, Langmuir 2002, 18, 5314.
16. M. H. Lee, M. D. Huntington, W. Zhou, J. C. Yang and T. W. Odom, Nano Lett. 2010, 11, 311.
17. T. W. Odom, V. R. Thalladi, J. C. Love and G. M. Whitesides, Journal of American Chemical Society 2002, 124, 12112
18. J. Henzie, J. Lee, M. H. Lee, W. Hasan and T. W. Odom, Annu. Rev. Phys. Chem. 2009, 60, 147.
19. J. A. Rogers and R. G. Nuzzo, Materials Today 2005, 8, 50.
20. H. Gao, J. C. Yang, J. Y. Lin, A. D. Stuparu, M. H. Lee, M. Mrksich and T. W. Odom, Nano Lett. 2010, 10, 2549
21. H. Gao, J. Henzie, and T. W. Odom, Nano Lett. 2006, 6, 2104
22. H. Gao, J. Henzie, M. H. Lee and T. W. Odom, Proc. Natl. Acad. Sci. 2008, 105, 20146.
23. Rolland, J. P.; Maynor, B. W.; Euliss, L. E.; Exner, A. E.; Denison, G. M.; DeSimone, J. M. J. Am. Chem. Soc. 2005, 127, 10096-10100.
24. D. B. Weibel, W. R. DiLuzio and G. M. Whitesides, Nat. Rev. Microbiol. 2007, 5, 209.
25. H. Wu, T. W. Odom and G. M. Whitesides, Anal. Chem. 2002, 74, 3267.
26. M. H. Wu and G. M. Whitesides, Appl. Phys. Lett. 2001, 78, 2273.
27. G. M. Whitesides, Nature 2006, 442, 369
28. H. A. Stone, A. D. Stroock and A. Ajdari, Annual Review of Fluid Mechanics 2004, 36, 381.
29. S. P. Price, J. Henzie, and T. W. Odom Small, 2007, 3(3), 372-374.

We claim:

1. A lens-less photolithography system comprising a light source having a plurality of solid state light-emitting devices for illuminating a substrate.

2. The system of claim 1 wherein the solid state light-emitting devices comprise UV light-emitting diodes.

3. The system of claim 2 wherein the light-emitting diodes are selected from semiconductor light-emitting diodes, organic light-emitting diodes, and polymer light-emitting diodes.

4. The system of claim 3 wherein the semiconductor light-emitting diodes comprise UV light-emitting GaN.

5. The system of claim 1 wherein the solid state light-emitting devices are arranged in an array.

6. The system of claim 1 wherein the light-emitting devices are selected to emit a wavelength of light that is compatible with a particular photoresist on the substrate.

7. The system of claim 1 further comprising a light diffuser between the light source and the substrate.

8. The system of claim 7 wherein the light diffuser is a ground glass light diffuser.

9. The system of claim 1 wherein the light-emitting devices are powered by a battery power source.

10. A photolithography system comprising a light source having a plurality of solid state light-emitting devices for illuminating a substrate, wherein certain light-emitting devices are more or less energized than others to improve uniformity of illumination.

11. The system of claim 10 wherein the solid state light-emitting devices comprise UV light-emitting diodes.

12. The system of claim 11 wherein the light-emitting diodes are selected from semiconductor light-emitting diodes, organic light-emitting diodes, and polymer light-emitting diodes.

13. The system of claim 12 wherein the semiconductor light-emitting diodes comprise UV light-emitting GaN.

14. The system of claim 10 wherein the solid state light-emitting devices are arranged in an array.

15. The system of claim 10 wherein the light-emitting devices are selected to emit a wavelength of light that is compatible with a particular photoresist on the substrate.

16. The system of claim 10 further comprising a light diffuser between the light source and the substrate with or without a lens.

17. The system of claim 16 wherein the light diffuser is a ground glass light diffuser.

18. The system of claim 10 wherein the light-emitting devices are powered by a battery power source.

19. A photolithographic method, comprising directing light from a plurality of solid state light-emitting devices toward a substrate without a lens between the solid state light-emitting devices and the substrate.

20. The method of claim 19 including passing the light from the solid state light-emitting devices through a light diffuser and then onto the substrate.

21. The method of claim 19 using a positive tone photoresist.

22. The method of claim 19 using a negative tone photoresist.

23. A photolithographic method, comprising directing light from a plurality of solid state light-emitting devices toward a substrate including energizing certain light-emitting devices in an array more or less than others to improve uniformity of illumination of the substrate.

24. The method of claim 23 including passing the light from the solid state light-emitting devices through a light diffuser and then onto the substrate.

25. The method of claim 23 using a positive tone photoresist.

26. The method of claim 23 using a negative tone photoresist.
